(19) United States
(12) Patent Application Publication
(10) Pub. No.: US 2017/0159519 A1
(43) Pub. Date: Jun. 8, 2017

(54) PNEUMATIC TOOL SOUND DAMPENING SYSTEM

(71) Applicant: Phillip Belveal, Pinedale, WY (US)

(72) Inventor: Phillip Belveal, Pinedale, WY (US)

(21) Appl. No.: 14/959,751

(22) Filed: Dec. 4, 2015

(51) Int. Cl. F01N 1/06; B25D 17/12; B25F 5/00

(52) U.S. Cl. CPC F01N 1/06; B25F 5/00; B25D 17/12

(57) ABSTRACT

A pneumatic tool sound dampening system includes a housing that has a first end, a second end and a perimeter wall extending between the first and second ends. The first and second ends are open. The housing includes a first section including the first end and a second section including the second end. The first end is fluidly coupled to an exhaust port of the pneumatic drive apparatus. An interior of the first section forms an expanding cone extending toward the second section. A funnel is positioned within the second section. The funnel forms a decreasing cone extending away from the first section and toward the second end. The funnel is fluidly coupled to the second end.

### BACKGROUND OF THE DISCLOSURE

### Field of the Disclosure

The disclosure relates to hand tool muffling devices and more particularly pertains to a new hand tool muffling device for decreasing the amplitude of sound emitted from a pneumatically driven tool.

### SUMMARY OF THE DISCLOSURE

An embodiment of the disclosure meets the needs presented above by generally comprising a housing that has a first end, a second end and a perimeter wall extending between the first and second ends. The first and second ends are open. The housing includes a first section including the first end and a second section including the second end. The first end is fluidly coupled to an exhaust port of the pneumatic drive apparatus. An interior of the first section forms an expanding cone extending toward the second section. A funnel is positioned within the second section. The funnel forms a decreasing cone extending away from the first section and toward the second end. The funnel is fluidly coupled to the second end.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a pneumatic tool sound dampening system according to an embodiment of the disclosure.

FIG. 2 is an exploded perspective view of an embodiment of the disclosure.

FIG. 3 is an exploded, rear perspective view of an embodiment of the disclosure.

FIG. 4 is a side in-use view of an embodiment of the disclosure.

FIG. 5 is a cross-sectional view of an embodiment of the disclosure taken along line 5-5 of FIG. 4.

FIG. 6 is a cross-sectional view of an embodiment of the disclosure taken along line 6-6 of FIG. 5.

### DESCRIPTION OF THE PREFERRED EMBODIMENT

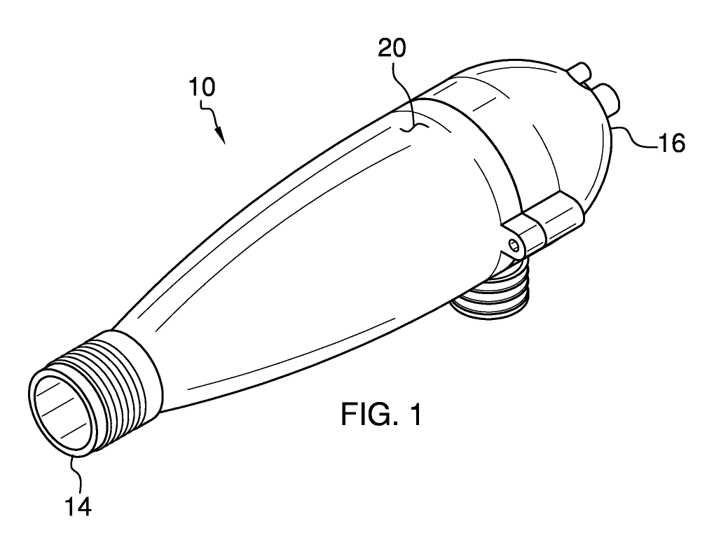

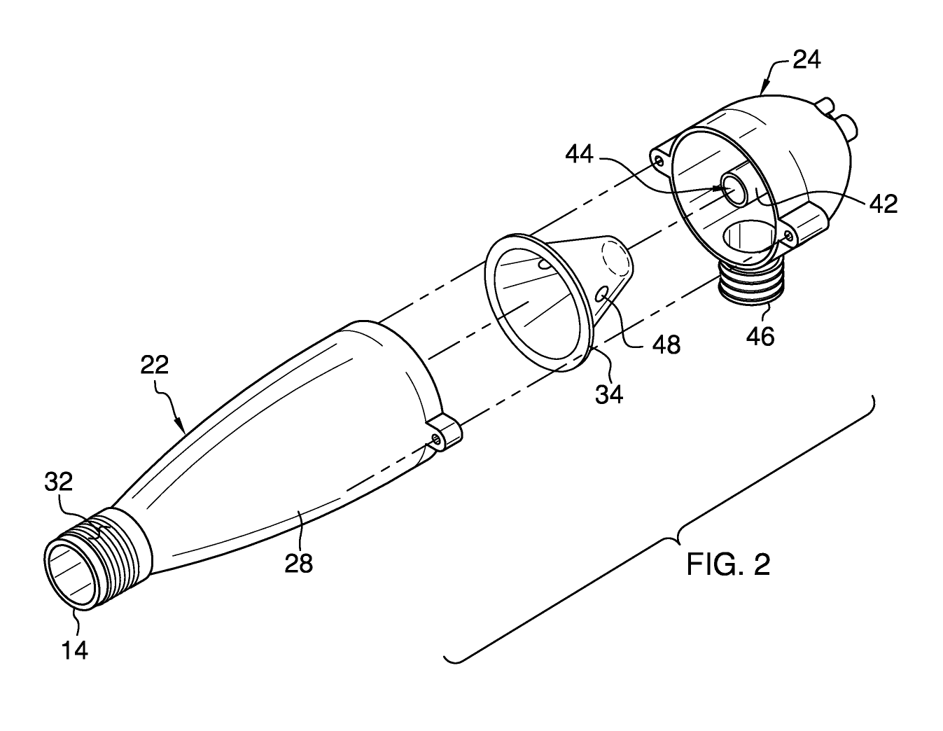

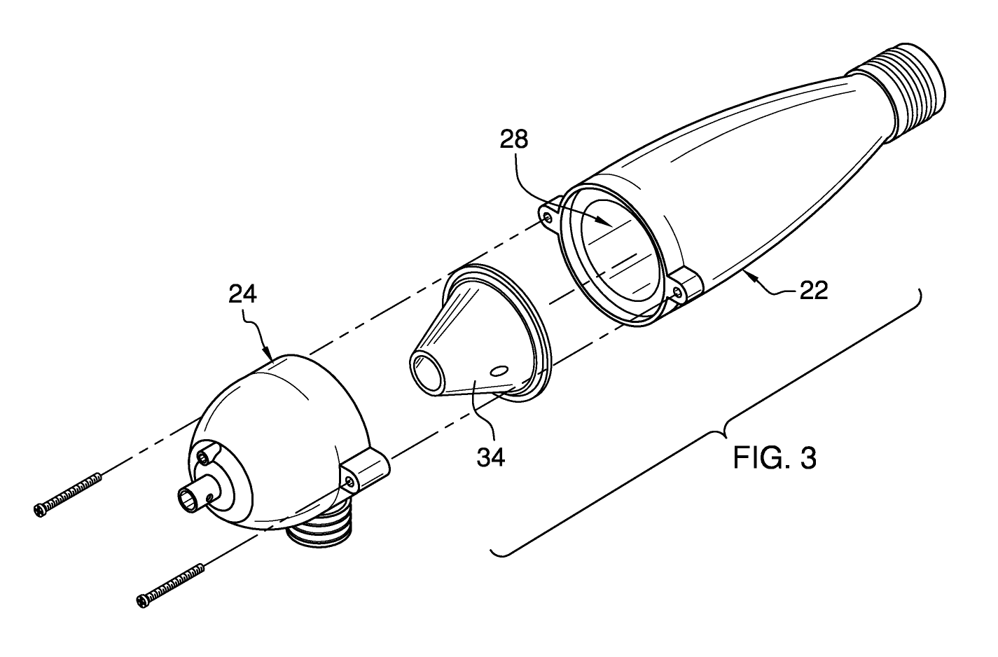

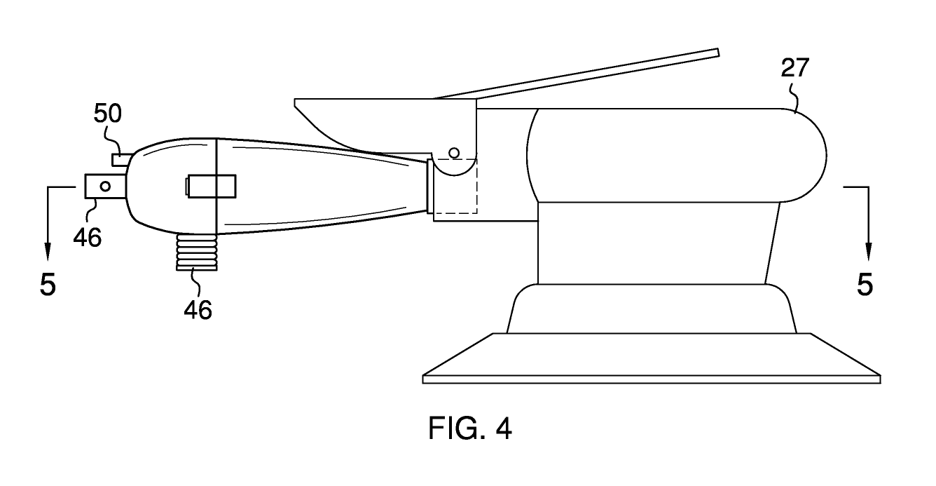

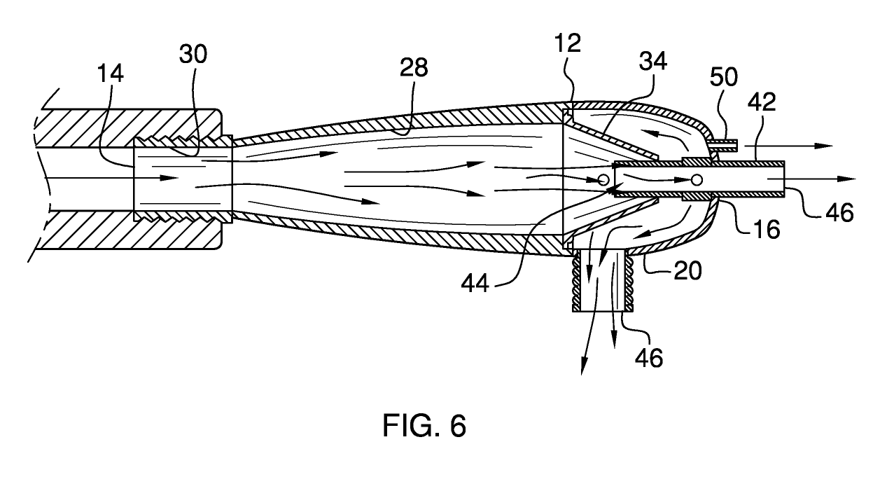

With reference now to the drawings, and in particular to FIGS. 1 through 6 thereof, a new hand tool muffling device embodying the principles and concepts of an embodiment of the disclosure and generally designated by the reference numeral 10 will be described.

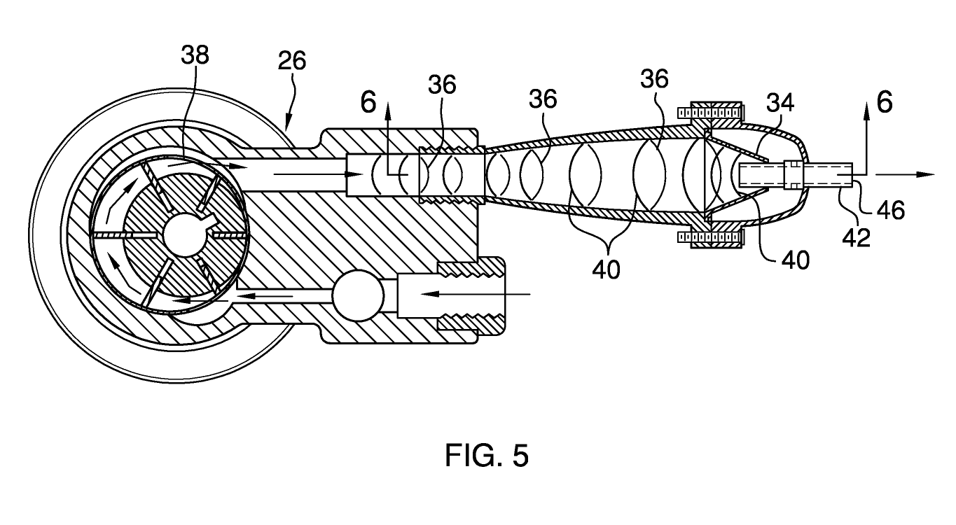

As best illustrated in FIGS. 1 through 6, the pneumatic tool sound dampening system 10 generally comprises a housing 12 having a first end 14, a second end 16 and a perimeter wall 20 extending between the first 14 and second 16 ends. The first 14 and second 16 ends are open. The housing 12 includes a first section 22 including the first end 14 and a second section 24 including the second end 16. The first end 14 is configured to be fluidly coupled to an exhaust port of the pneumatic tool, or more generally, a pneumatic drive apparatus 26 of a pneumatic tool. An interior of the first section 22 forms an expanding cone 28 extending toward the second section 24. A cylinder 30 may be positioned between the first end 14 and the expanding cone 28. The outer surface 32 of the cylinder 30 is coupled to the pneumatic drive apparatus 26 and may be threaded to threadably engage the pneumatic drive apparatus 26. The pneumatic drive apparatus 26 may comprise, for example, an air vane motor assembly as shown in FIG. 5, though any pneumatic tool 27 including a hand sander, drill, impact hammer or the like utilizing pressurized air as a power source may be included with the system 10.

A funnel 34 is positioned within the second section 24. The funnel 34 forms a decreasing cone extending away from the first section 22 and toward the second end 16. As is demonstrated in FIG. 5, sound waves created by air moving through the pneumatic tool 27 moves in forward shock waves 36 formed by the air outlet 38 of an impeller chamber as impeller blades 40, or vanes, move past the air outlet 38. The forward shock waves 36 expand through the first section 22 and then contract in the funnel 34. As the forward shock waves 36 reach the distal end of the funnel 34 relative to the first end 22, the forward shock waves 36 reflect backwards to define reverse shock waves 40. The reverse shock waves 40 interact with the forward shock waves 36 to weaken them and to reduce the amplification of the sound emitted from the housing 12.

A tube 42 is attached to the funnel 34 and extends through a proximate end of the funnel 34 with respect to the second end 16. The tube 42 forms a connection with the funnel 34 where the forward shock waves 36 can rebound where the tube 42 abuts the funnel 34. The tube 42 has an air release hole 44 therein which is positioned within the funnel 34. As the air flows into the funnel 34 it exits the funnel 34 through the air release hole 44 and then leaves the housing 12 by way of the tube 42 which extends through the second end 16. The tube 42 has a distal end 46 with respect to housing 12 which is open to release the air. The tube 42 may be releasably secured to the housing 12 such that the tube 42 and the funnel 34 are movable relative to the housing 12. The tube 42 may be threadably secured to the housing 12 wherein the funnel 34 is movable relative to the housing 12 by rotating the tube 42 relative to the housing 12. By moving the funnel 34 toward or away from the first section 22, the user of the system 10 can tune the system 10 to maximize the muffling properties of the housing 12. In this manner, the system 10 can be easily retrofitted to different pneumatic tools 27 though it should be understood the housing 12 may be provided such that it is not removable from the pneumatic tool 27.

An exhaust conduit 46 may be fluidly coupled to the second section 24. The exhaust conduit 24 may eject air that escapes through one or more apertures 48 in the funnel 34 that release air into the space between the perimeter wall 20 and the funnel 34. The air that escapes from the exhaust conduit 46 may be directed downwardly for use in cleaning off a work area, particularly one that is being sanded. For this reason, the housing 12 has a longitudinal axis extending through the first 14 and second 16 ends wherein the exhaust conduit 46 forms an angle with respect to the longitudinal axis between 45° and 135°. The exhaust conduit 46 may be threaded for receiving a hose or a cap. A secondary exhaust conduit 50 may be provided if needed to release a larger volume of air wherein the secondary exhaust conduit 50 extends rearwardly for the second section 24.

In use, the pneumatic tool 27 is used in a conventional manner, however the housing 12 is coupled to the exhaust port 52 of the pneumatic tool 27 to lesson the sound amplitude of the pneumatic tool 27. The system 10 may further be sued to direct air across a work station to clear material from the work station during usage of the pneumatic tool 27.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A sound dampener assembly comprising:
a pneumatic drive apparatus;
a housing having a first end, a second end and a perimeter wall extending between said first and second ends, said first and second ends being open, said housing including a first section including said first end and a second section including said second end, said first end being fluidly couplable to an exhaust port of the pneumatic drive apparatus, an interior of said first section forming an expanding cone extending toward said second section; and
a funnel being positioned within said second section, said funnel forming a decreasing cone extending away from said first section and toward said second end, said funnel being fluidly coupled to said second end, said funnel having a proximate end with respect to said second end, said proximate end being open.

2. The sound dampener assembly according to claim 1, wherein a distance between said funnel and said second end is adjustable.

3. The sound dampener assembly according to claim 1, further including a tube being attached to said funnel and extending through a proximate end of said funnel with respect to said second end, said tube extending through said second end.

4. The sound dampener assembly according to claim 3, wherein said tube is releasably secured to said housing such that said tube and said funnel are movable relative to said housing.

5. The sound dampener assembly according to claim 1, further including an exhaust conduit being fluidly coupled to said second section.

6. The sound dampener assembly according to claim 5, wherein said housing has a longitudinal axis extending through said first and second ends, said exhaust conduit forming an angle with respect to said longitudinal axis between 45° and 135°.

7. A sound dampener assembly comprising:
a pneumatic drive apparatus;
a housing having a first end, a second end and a perimeter wall extending between said first and second ends, said first and second ends being open, said housing including a first section including said first end and a second section including said second end, said first end being fluidly couplable to an exhaust port of the pneumatic drive apparatus, an interior of said first section forming an expanding cone extending toward said second section;
a funnel being positioned within said second section, said funnel forming a decreasing cone extending away from said first section and toward said second end, said funnel having a proximate end with respect to said second end, said proximate end of said funnel with respect to said second end being open;
a tube being attached to said funnel and extending through said proximate end of said funnel with respect to said second end, said tube extending through said second end, said tube being releasably secured to said housing such that said tube and said funnel are movable relative to said housing; and
an exhaust conduit being fluidly coupled to said second section, said housing having a longitudinal axis extending through said first and second ends, said exhaust conduit forming an angle with respect to said longitudinal axis between 45° and 135°.
